(19) United States
(12) Patent Application Publication
(10) Pub. No.: US 2004/0220861 A1
(43) Pub. Date: Nov. 4, 2004

(54) Making purchase decisions

(76) Inventors: Michal Morciniec, Bristol (GB); Claudio Bartolini, Menlo Park, CA (US); Andrew Robert Byde, Cardiff (GB); Christopher William Preist, Bristol (GB); Mathias Jean Rene Salle, San Francisco, CA (US)

Correspondence Address: HEWLETT-PACKARD COMPANY, Intellectual Property Administration, P.O. Box 272400, Fort Collins, CO, 80527-2400, US

(21) Appl. No.: 10/698,849

(22) Filed: Oct. 31, 2003

(30) Foreign Application Priority Data
Oct. 31, 2002 (GB) 0225422.5

(51) Int. Cl. G06F 17/60

(52) U.S. Cl. 705/26

(57) ABSTRACT

Apparatus according to an exemplary embodiment of the present invention comprises a contract repository (200) in which details of each of a plurality of contracts established with a supplier of a good or service is stored. Similarly, each of a plurality of purchase orders (30) submitted by one or more buyers are stored in a purchase order repository 300. A subsystem (1) for linking purchase orders (30) to contracts (20) and for aggregating information is provided.

The subsystem (1) employs a linking table (10) for recording links between contracts (20) and purchase orders (30). The linking table (10) in an exemplary embodiment of the present invention includes a column (101) for recording contract identifiers (201) in respect of contracts (20) used to realise purchase orders (30) a column (102) for recording in respect of each contract identifier (201) a list of purchase order identifiers denoting purchase orders realised using that particular contract, and a table (103) of aggregate attributes in respect of all realised purchase orders. In a described example, the table (103) of aggregate attributes includes the total quantity (501) of goods purchased using each contract, and the current discount level (502) in respect of each contract.

At any time, when a link between a contract identifier and a purchase order identifier is generated, the table (103) of aggregated attributes is also updated. Thus, the aggregated quantity (501) (which comprises the total quantity of goods purchased using a particular contract) is updated to reflect the additional quantity of goods purchased in respect of the contract. This value (501) is then used to determine the current discount level (502) which applies to that contract.

### FIELD OF THE INVENTION

This invention relates generally to the purchase of goods and services and, more particularly, to a method and apparatus for use in making a purchase decision regarding purchase of a plurality of units of a good or service from a plurality of different potential suppliers.

### BACKGROUND TO THE INVENTION

It is common practice for commercial organisations to distribute their purchasing requirements for one or more goods and services among a number of approved suppliers. There are a number of advantages to the adoption of this strategy, including the ability to monitor and even control the market price per unit of the goods and services in question. Further, this provides the organisation with the ability to purchase any required number of units of a good or service at short notice at the best available price.

Generally, in such cases, long-term “framework” contracts may be negotiated and effected between the purchasing organisation and each approved supplier, which contracts often do not specify a particular quantity of a good or service to be purchased during the contract period, but instead specify discounts which will apply if the quantity of the good or service purchased exceeds some predetermined level. Cost penalties may additionally or alternatively be specified in the event that the quantity of the good or service purchased during the contract period falls below some pre-arranged minimum. Thus, contracts are often established with multiple suppliers, each having different validity dates and volume discounts and delivery terms, but potentially concerning the same type of good or service.

Within such organisations, procurement functions are often spread across an organisation between different departments, and sometimes even geographically, such that the personnel responsible for negotiating and effecting long-term procurement contracts with a set of approved suppliers, may be in a different department, or even in a different geographical location, to the various personnel responsible for purchasing quantities of the goods and services required for each respective department. As a result, the information about what purchase orders have been raised in the context of a particular contract may be scattered around an organisation, such that the organisation may not be able to optimise the contract clauses such as those relating to aggregated quantity discount.

U.S. Pat. No. 6,078,897 provides a method and apparatus for optimising orders for goods or services in order to optimise a discount negotiated and specified in a single procurement contract between a supplier and, for example, an organisation. Thus, members of the organisation can place their order for a good, and the described apparatus collects all of the orders together and submits them as a single large order which will then be entitled to the volume discount specified in the above-mentioned contract, with the result that the price per unit to the members of the organisation can be reduced. However, the described method relates to a single transaction between the organisation and a supplier of the goods. It does not address the issue of handling multiple transactions at spaced-apart time intervals and maximising discounts (and minimising cost penalties, where appropriate) in the context of one or more long-term procurement contracts.

### SUMMARY OF THE INVENTION

In accordance with a first aspect of the present invention, there is provided apparatus for use in making a purchase decision regarding purchase of a plurality of units of a good or service at a particular purchasing time from a plurality of potential suppliers, the apparatus comprising means for determining or otherwise obtaining a total quantity of units of said good or service required to-be purchased at said purchasing time as defined by one or more purchase orders relating to said purchasing time, means for accessing details of terms under which said good or service may be purchased from each of said potential suppliers at said purchasing time, and means for providing an indication of one or more consequences of allocating portions of said total quantity to be purchased among said plurality of potential suppliers.

Also in accordance with the first aspect of the present invention, there is provided a method for use in making a purchase decision regarding purchase of a plurality of units of a good or service at a particular purchasing time from a plurality of potential suppliers, the method comprising the steps of determining or obtaining a total quantity of units of said good or service required to be purchased at said purchasing time as defined by one or more purchase orders generated in respect of said purchasing time, accessing details of terms under which said good or service may be purchased from each of said potential suppliers at said purchasing time, and providing an indication of one or more consequences of allocating portions of said total quantity to be purchased among said plurality of potential suppliers.

The terms are preferably defined in respective contracts, with at least one contract being established in respect of each potential supplier. The apparatus beneficially includes a contract repository in which details of each contract established in respect of the suppliers are stored.

Each contract may be encoded as a record prior to storage thereof. Each record may include one or more of a unique contract identifier, a start date and an end date of the respective contract, a good type, and a delivery location. The terms under which the good or service may be purchased from the respective suppliers is preferably also included in the encoded contract record. Such terms may include a volume discount, preferably expressed as a discount function, defining a discount as a function of a quantity of the good or service in question.

The apparatus preferably includes means for storing the one or more purchase orders, which are beneficially encoded prior to storage thereof. The or each purchase order may be encoded in terms of one or more of an order due date, a good type, a quantity of the good specified in the purchase order, and a buyer location.

The apparatus preferably includes a linking table for recording or defining links between contracts and purchase orders. An aggregated quantity of goods or services purchased in respect of each contract is preferably stored in the linking table.

The apparatus beneficially also includes a procurement decision interface which provides a visual indication of the consequences referred to above. The procurement decision interface may be arranged to provide an indication of, for example, an average price per unit of a good required to be purchased, given that the total quantity of goods required at a specific purchasing time is allocated between a selected set of contracts in quantities prescribed by a user. The apparatus may further include a data structure for storing a repository of demand schedules, representing future demand of a good or service.

In accordance with a second aspect of the present invention, there is provided apparatus for use in making a purchase decision regarding purchase of a plurality of units of a good or service at a particular purchasing time from a plurality of potential suppliers, the apparatus comprising, an input for receiving details of one or more purchase orders generated in respect of said purchasing time, and for receiving details of contracts relating to purchase of said good or service, at least one contract being defined in respect of each of said plurality of potential suppliers, said apparatus being arranged to define a link between said purchase orders and related contracts.

In accordance with a third aspect of the present invention, there is provided apparatus for use in making a purchase decision regarding purchase of a plurality of units of a good or service at a current purchasing time from a plurality of potential suppliers, the apparatus comprising an input for receiving details of one or more purchase orders generated in respect of each of a plurality of previous purchasing times and for receiving details of contracts relating to purchase of said good or service, at least one contract being defined in respect of each of said plurality of potential suppliers, and a processor for determining from said details of said one or more purchase orders a total quantity of said good or service purchased in respect of each of said contracts at said previous purchasing times and for updating said total quantities in respect of each of said contracts according to an allocation among said plurality of potential suppliers of a quantity of said good or service purchased at said current purchasing time.

Thus, the first, second and third aspects of the present invention enable information relating to aggregated purchasing requirements to be collected and stored, and may provide a link between that information and information relating to various relevant contracts which may exist such that, if multiple procurement contracts exist for a particular good or service, the total order quantity can be divided and assigned in various proportions to contracts so as to maximise the value of the discount or minimise the value of any cost penalty.

In other words, the first, second and third aspects of the present invention may give an indication of consequences of applying selected allocations of a total quantity of a good or service required to be purchased among a plurality of suppliers (and, therefore, between associated contracts). These consequences are generally based on previous demand (i.e. the total quantities of a good or service purchased in respect of each contract) and the terms of the relevant contracts (such as, for example, discounts and/or cost penalties). Based on these consequences, a procurement specialist can make a purchase decision. However, in the case of the first aspect of the present invention, it may be up to the user to interpret the consequences correctly and make the optimal purchase decision.

Thus, in accordance with a fourth aspect of the present invention, there is provided apparatus for use in making a purchase decision regarding purchase of a plurality of units of a good or service from a plurality of potential suppliers at each of a plurality of purchasing times within a predetermined period, the apparatus comprising means for receiving data representative of a total quantity of units of said good or service required to be purchased at each of said purchasing times, means for accessing details of terms under which said good or service may be purchased from each of said potential suppliers at said purchasing times, means for determining an optimal purchase decision regarding purchase of said plurality of units of said good or service based on a total quantity of units required to be purchased within said predetermined period and said terms, said optimal purchase decision being defined in terms of allocation among said plurality of potential suppliers of said total quantity of said good or service required to be purchased at each of said purchasing times so as to minimise a total cost of purchasing said good or service during said predetermined period.

Also in accordance with the fourth aspect of the present invention, there is provided a method for use in making a purchase decision regarding purchase of a plurality of units of a good or service from a plurality of potential suppliers at each of a plurality of purchasing times within a predetermined period, the method comprising the steps of receiving data representative of a total quantity of units of said good or service required to be purchased at each of said purchasing times, accessing details of terms under which said good or service may be purchased from each of said potential suppliers at said purchasing times, and determining an optimal purchase decision regarding purchase of said plurality of units of said good or service based on a total quantity of units required to be purchased within said predetermined period and said terms, said optimal purchase decision being defined in terms of allocation among said plurality of potential suppliers of said total quantity of said good or service required to be purchased at each of said purchasing times so as to minimise a total cost of purchasing said good or service during said predetermined period.

Thus, in the case of the fourth aspect of the present invention, it may be assumed that an organisation has a known purchase schedule over some period of time (say, 6 months) and a set of master contracts with different suppliers which define the terms under which a good or service may be purchased from those suppliers during the above-mentioned period of time. Such terms may, for example, include cumulative purchase discounts within this period (e.g. once you have bought 1000 units from us, you will receive a 10% discount in respect of all subsequent purchases within this period). Optionally, the organisation may have constraints on purchases from one supplier (e.g. no more or no less than X units within a given time window). The fourth aspect of the invention is intended to provide a method and apparatus for recommending a purchase strategy over this period which (preferably) results in minimal expenditure.

### BRIEF DESCRIPTION OF THE DRAWINGS

Embodiments of the present invention will now be described by way of examples only and with reference to the accompanying drawings, in which:

FIG. 1 is a schematic block diagram of an information and contract management system for use in an exemplary embodiment of the present invention;

FIG. 2 is a schematic block diagram of a purchase decision interface for use in apparatus according to an exemplary embodiment of the present invention;

FIG. 3 is a schematic block diagram illustrating the primary components of apparatus according to an exemplary embodiment of the second aspect of the present invention; and

FIG. 4 is a flow diagram illustrating a method according to an exemplary embodiment of the present invention.

### DETAILED DESCRIPTION OF AN EMBODIMENT OF THE INVENTION

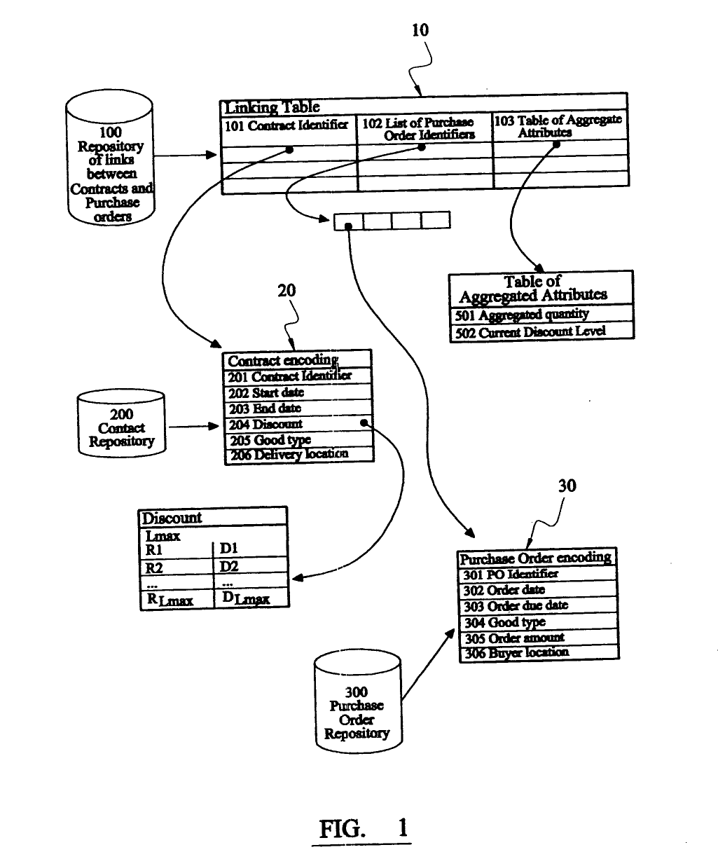

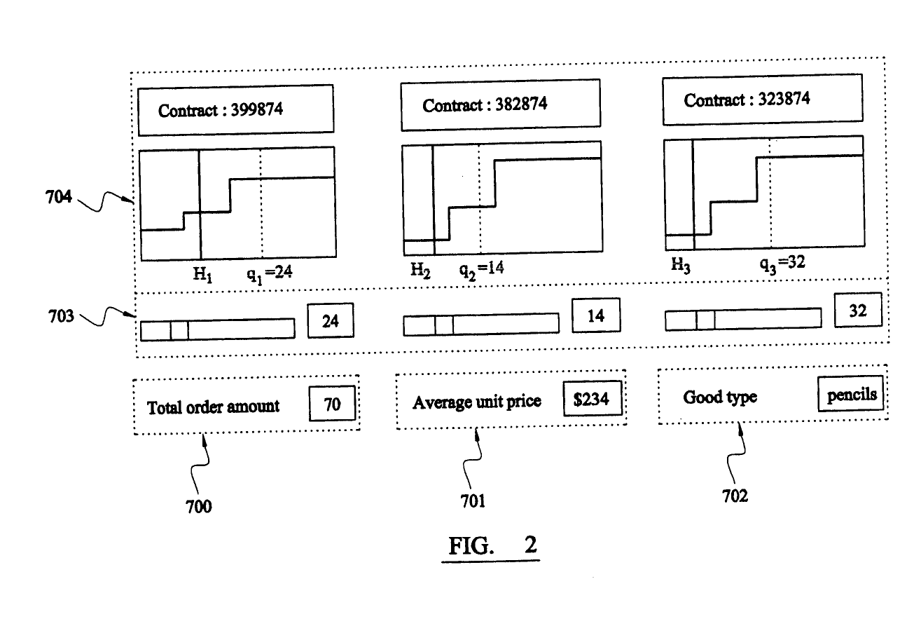

Referring to FIG. 1 of the drawings, apparatus according to an exemplary embodiment of the present invention comprises a contract repository 200 in which each contract established with a supplier of a good or service is stored. Prior to storage, each contract 20 is broken down, and encoded in terms of its pertinent information. In the example shown, each contract is encoded as a record including a unique contract identifier 201, the start date 202 and the end date 203 of the contract, the good type 205, and the delivery location 206. In addition, the terms, such as the volume discount specified in a contract, are also included in the encoded contract record 20. The discount 204 is defined (in this exemplary embodiment of the invention) in terms of a discount function (preferably, but not necessarily, a step function) specifying the number of discount levels Lₘₐₓ, the amount of goods Rᵢ which must be exceeded to entitle the buyer to a discount of Dᵢ% on the price of the transaction (i.e. the contract terms in this case are defined as discounts as functions of respective quantities). It will be appreciated that, at least in the case of this exemplary embodiment of the invention, it makes no difference what the price per unit of the good is: it could be fixed in the contract, pre-agreed to be linked to some external parameter (such as the existing market for the good) or negotiated at the time of transaction. In any event, the purchase price per unit of the good needs to be specified (for this embodiment) in some way.

The contracts 20 can be encoded in terms of the above or similar types of pertinent information in any convenient manner, and the present invention is not intended to be limited in this respect. Thus, for example, XML encoding could be used, or the contract information could be stored as a database table, or each contract could be stored in a conventional record format, etc. Whichever method is chosen, a person skilled in the art will appreciate that pertinent information relating to each contract can be encoded in some way and that each encoded contract can be stored in the contract repository 200.

In a similar manner, each purchase order 30 can be encoded in terms of its pertinent information, namely, for example, a unique purchase order identifier 301, the order date 302 (i.e. the date on which the purchase order was generated), the order due date 303 (i.e. the date on which the goods specified in a particular purchase order are required to be delivered), the good type 304, the quantity 305 of the good specified in the purchase order, and the buyer location 306 (i.e., for example, the department, branch or site of an organisation from which the purchase order originates). Again, it will be appreciated by a person skilled in the art that there are many different ways of encoding the purchase orders 30 in terms of their pertinent data. Thus, irrespective of the method chosen, any purchase orders 30 submitted by the buyers are encoded and stored in a purchase order repository 300.

The apparatus shown in FIG. 1 of the drawings further comprises a subsystem 1 for linking purchase orders 30 to contracts 20, and for aggregating information.

The subsystem 1 employs a linking table 10 for recording links between contracts 20 and purchase orders 30. The linking table 10, in this exemplary embodiment of the present invention includes a column 101 for recording contract identifiers 201 in respect of contracts 20 used to realise purchase orders 30, a column 102 for recording in respect of each contract identifier 201 a list of purchase order identifiers denoting purchase orders realised using that particular contract, and a table 103 of aggregate attributes in respect of all realised purchase orders. In this example, the table 103 of aggregate attributes includes the total quantity 501 of goods purchased using each contract, and the current discount level 502 in respect of each contract.

In more detail, every entry in the table 10 is indexed by a contract identifier 101 and contains information about what purchase orders have been raised in connection with each contract.

Thus, when a purchase order is raised, an entry is made in the purchase order repository 300 and this entry includes a purchase order identifier 301. When a decision is made to realise the order using a specific contract, the purchase order identifier 301 is added to the linking table 10 against that contract (identified in the table by its contract identifier 201). In other words, the purchase order identifier 301 is added to the list of purchase order identifiers 102 in the column of the linking table 10 denoted by the particular contract identifier 101 having the value equal to the identifier 201 of the selected contract 20.

At any time, when a link between a contract identifier and a purchase order identifier is generated, the table 103 of aggregated attributes is also updated. Thus, the aggregated quantity 501 (which comprises the total quantity of goods purchased using a particular contract) is updated to reflect the additional quantity of goods purchased in respect of the contract. This value 501 is then used to determine the current discount level 502 which applies to that contract. It will be appreciated that, in order to calculate the current discount level 502, the discount function 204 is retrieved for the contract with identifier 201 listed in the column 101 of the table 10, and the sum 501 of the ordered amounts (305) is compared with thresholds Rᵢ to identify the discount value Dᵢ which applies at any particular time to goods purchased in respect of the contract in question. It can be seen therefore, that the method and apparatus according to this exemplary embodiment of the invention can be used at any time to query the system for the discount value which will apply if a specific purchase order transaction is assigned to a given contract.

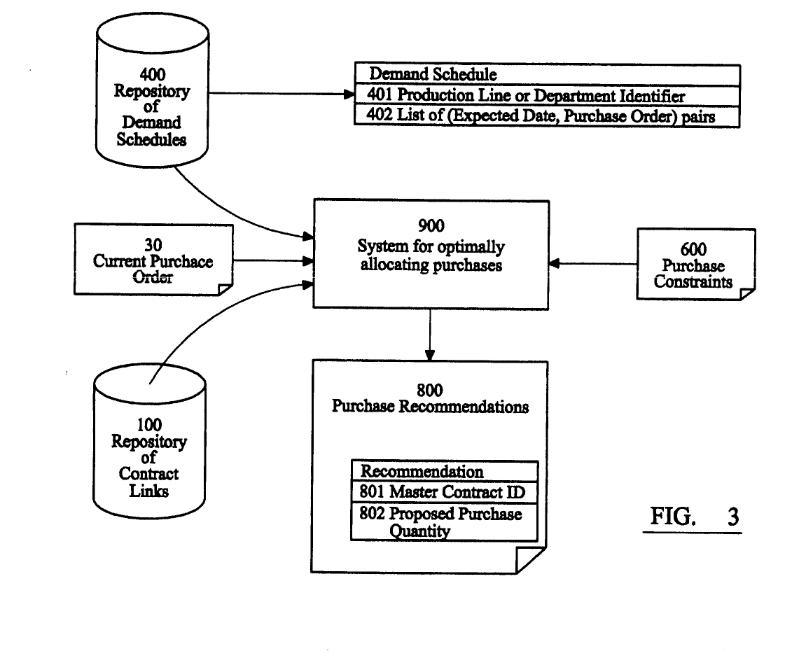

Referring now to FIG. 2 of the drawings, the apparatus according to an exemplary embodiment of the present invention includes a procurement decision interface 70 which effectively provides a visual and/or numerical indication of an average price per unit of a good required to be ordered, given that the total quantity of goods required at a specific purchasing time is allocated between a selected set of contracts in quantities prescribed by a user (e.g. a procurement specialist).

The interface 70 illustrated in FIG. 2 provides, for each contract, a contract number 705, a graphical illustration 704 of the discount function as a stepped function of discount value against quantity of goods, an indication of the total quantity H of goods purchased in respect of the contract to-date, and an indication of H (as denoted in each case by the broken vertical line) if a proposed quantity q of goods is purchased at the current purchasing time. In addition, an assignment panel 703 is provided for enabling the total quantity of goods required to be purchased at the current purchasing time to be allocated among the selected contracts. In the example shown, the assignment panel 703 is realised using a graphical widget such as a graded slider for each respective contract. However, it will be appreciated the assignment panel, if provided, may be implemented in many different ways (including simple numerical values) and the invention is not intended to be limited in this regard.

In addition, an indication is given of the total quantity 700 of goods required to be ordered at the current purchasing time, the average unit price 701 given the allocation of goods indicated by the assignment panel 703, and the type 702 of good to which the provided decision interface 70 relates.

In use, the procurement specialist enters the type of good 702 required to be purchased. A query is sent to the contract repository 200 and a set of valid contracts which exist in respect of the selected good are retrieved and presented in the decision interface 70. At the same time, a query is sent to the purchase order repository 300 and the total order amount is calculated by adding order amounts 305 of all orders. The total order amount is displayed in the appropriate panel 700. This total amount 700 can be selectively assigned between the presented contracts by the procurement specialist using the assignment panel 703. As stated above, the assignment panel 703 may be implement by means of a graphical widget such as a graded slider, with the position of the slider representing the quantity q_{c} which the user allocates to each contract. In the event that any constraints are required to be applied, for example, a minimum quantity of goods required by a particular contract to be allocated to a particular seller or a maximum quantity permitted to be allocated to a single seller, the slider is preferably arranged such that it can only move between these maximum and minimum quantities.

For each allocated quantity of goods, the aggregated quantity H (501) is retrieved from the linking table 10 and the discount function 204 is retrieved from the contract repository entry relating to the contract identifier 201 recorded in the column 101 of the table 10. The discount function for each contract is plotted in an associated graphical panel and the aggregated quantity H in each case is identified (in the example shown, by an unbroken vertical line). In addition, the aggregated quantity for that contract if the proposed quantity q_{c} of goods is purchased therefrom is also indicated in the graphical panel (by the broken vertical line). This gives a convenient visual indication of the discount function and the discount level that will apply if the proposed quantity q_{c} of goods is purchased from a particular contract.

The system may also be arranged to calculate or otherwise derive some relevant information, such as the average unit price of goods purchased according to the selected allocation or the total gross and net price and discount, for example. In the example shown, this information is displayed in the panel 701 and enables the procurement specialist to compare the benefits of allocating the quantities of good defined by the purchase orders relating to a particular purchasing time between the valid contracts which exist for that type of good.

Thus, the exemplary embodiment of the invention described above provides a system and method for using aggregated information about purchase orders issued in the context of longer term procurement contracts, so as to assist in the decision making process required to allocate quantities of a good or service to be purchased among sellers. It provides an information system which stores associations or links between master contracts and purchase orders, and some attributes of purchase orders that are relevant to the decision making process (such as the total quantity of goods purchased so far in respect of each relevant contract). The described arrangement further provides a contract management system for encoding and storing information relating to procurement contracts (i.e. variables such as discount function, contract validity dates and delivery terms) and a user interface allowing for assignment of purchase quantities between multiple contracts so as to maximise the discount that was negotiated in the master contract. The arrangement may also provide an order fulfilment system for sending and aggregating purchase orders and correlating multiple shipped quantities to original purchase orders.

One of the primary advantages of the arrangement described above, is the provision of links between contracts and purchase orders and the recordal of aggregated information relating to those purchase orders and contracts. It is these features which enable a procurement specialist or other user to make an informed decision as to how to allocate a quantity of goods required to be purchased among a plurality of sellers in order to maximise any discount specified in related contracts.

Apparatus according to an exemplary embodiment of the fourth aspect of the present invention may be provided in conjunction with the apparatus described with reference to FIGS. 1 and 2, either in the form of a purchase decision advisor (i.e. to provide a recommended optimal purchase decision to the user of the apparatus described above), in the context of a decision support tool for managing a set of master contracts. Alternatively, it could be used as an automated purchasing system. An embodiment of the second aspect of the present invention will now be described as an extension to the system described above in respect of the first aspect of the present invention.

Thus, referring to FIG. 3 of the drawings, in order to realise an exemplary embodiment of the fourth aspect of the invention, a data structure 400 may be added to the system illustrated in FIG. 1, which data structure 400 stores a repository of demand schedules associated with different departments or manufacturing products, say, of a purchasing organisation. Each demand schedule comprises a list of proposed purchase orders, together with expected date of execution. A system 900 for optimally allocating purchases receives a purchase order 30 (or set of purchase orders) which are required to be executed at a current purchasing time. The system 900 also receives a set of constraints 600. The constraints may take the form of upper and/or lower limits on quantities of a good or service that can be purchased from a given supplier at any one time. It will be appreciated that lower bounds can be “hard” (i.e. you must purchase at least quantity X from supplier Y) or “soft” (i.e. if you purchase from supplier Y, you must purchase at least quantity X).

For each item appearing in a purchase order set 30, the system 700 accesses the repository of demand schedules 400 to determine an aggregated demand schedule for it (i.e. future demand) and accesses the linking table 10 (FIG. 1) via the repository of contract links 100 to determine possible master contracts and past purchases made in the context of those contracts (i.e. the aggregated quantity 501 associated with each contract identifier 101). The system 900 then applies the algorithm described in more detail below, and returns purchase recommendations 800 in the form of a proposed quantity to be purchased in respect of each master contract. These recommendations could, for example, be fed directly to the procurement decision interface illustrated in FIG. 2 of the drawings, to be displayed to a user who can then accept the recommendations or override them. Alternatively, the purchase recommendations 800 may be executed directly, i.e. the apparatus may be arranged to generate orders for dispatch to each of the suppliers in accordance with the recommendations.

One algorithm which may employed by the system 900 of apparatus according to an exemplary embodiment of the present invention performs a search of possible allocations of purchases to master contracts. In the context of this exemplary embodiment, the allocation consists not only of a decision about which sellers to purchase from at the current purchasing time, but which sellers to purchase from at all future purchasing times in the demand schedule. The proposed algorithm exploits the fact that an optimal solution will be a corner case, i.e. the allocation of as much as possible to a subset of sellers, within the bounds of the maximum/minimum limits set by the constraints 600. Given this assumption, and the fact that, in practice, purchasing organisations tend to deal with a relatively small number of master contracts and purchasing periods/times at once, the algorithm described below effectively determines the optimal allocation, and hence the best purchase recommendations 800.

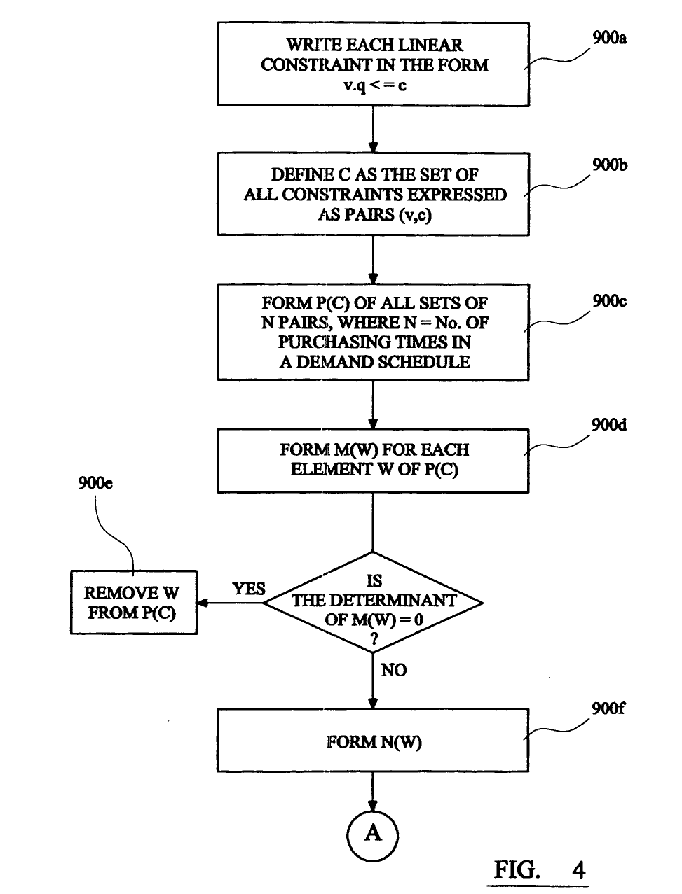

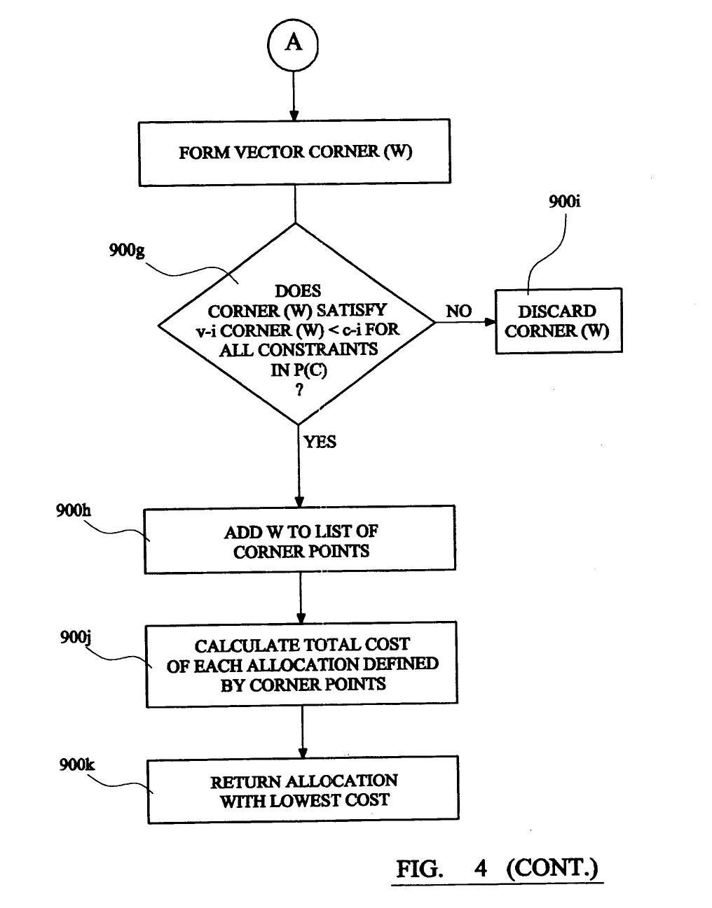

The purpose of the algorithm in this case is to generate all possible corner allocations within the bounds of the constraints 600 and it will be appreciated by a person skilled in the art of geometry that there may be several different ways of designing such an algorithm. One way to do this will now be described with reference to FIG. 4 of the drawings.

At step 900a, each constraint (which is assumed to be linear for the purposes of this description) is written or defined in the form v.q<c, where v is a vector with the same number of elements as the allocation vector q; c is a real number; and “.” is the so-called dot product, which is a process whereby components of v and c are multiplied pairwise and then summed to give a single real number.

At step 900b, C is defined as a set of all constraints, expressed as pairs (v, c). From C, the set P(C) is formed at step 900c, with P(C) comprising all sets of n pairs from C, where n is the total number of allocation variables, i.e. in this case, the number of purchase instances. For each element w of P(C), the matrix M(w) is formed (at step 900d) whose columns are the vectors v_j (where w=(v_{—}1,c_{—}1), . . . , (v_n,c_n)). In addition, if the determinant of a matrix M(w) is zero, that w is removed from P(C) at step 900e. For each w remaining in P(C), the matrix N(w) is taken at step 700f (where N(w) is inverse to M(w)) and multiplied by the column vector (c_{—}1, c_{—}2, . . . ,c_n) formed from the constants in w. The resulting vector is called comer(w), and is a potential corner point.

Next, it is determined, at step 900g, if comer(w) satisfies every constraint, i.e. does v_i.comer(w)≦c_i for all constraints (v_i, c_i) in P(C). If yes, then the corner(w) is added to the list of corner points (at step 900h). Otherwise, it is discarded (at step 700i).

Finally, the total cost of each allocation defined by the corner points is calculated (at step 900j). This can be achieved by calculating the total purchase from each seller through all purchasing times, and hence the total payment to that seller under the discount schedule specified in the associated master contract. The allocation with the lowest cost is then returned at step 900k.

It will be appreciated that, in the exemplary version of the invention described above, when demand and prices are fixed in advance, the variables q are indexed only by the purchase time t (in addition to seller and buyer). So if there are t purchase times, s sellers and B buyers, then the vector q is a vector q=(q\hat{ } {s_l, b_{—}1}_{—}1 . . . , q\hat{ } {s_S, b_B}_T of S*B*T integers. The vectors v-i have the same dimension; c-i are real numbers.

The main (mandatory) constraints of q (with regard to this exemplary embodiment of the invention) are specified below:

q_{Oi}^{sb}≧O

q_{Oi}^{sb}=Oifs∈St

$${\sum }_{s ∈ S}^{} {q}_{Ot}^{sb} = {do}_{Ot}^{b}$$

and relate to the necessity for quantities to be positive, to be zero for sellers that are unavailable at time t, and to add up, at each purchasing time, to the demanded quantity.

Thus,

1. There are T*B*S constraints of the first type of which v_j=(0, . . . , 0, −1,), 0, . . . , 0) (1 in the j\hat{ } {th} place) and c_j=0;

2. Each seller restriction of the form “the contract for seller s is not valid in time t” gives rise to 2*B constraints, 2 for each buyer. For each buyer the corresponding c is 0 as before, and the two vectors v have v\hat{ } {s,b} t=+/−1, all other components 0;

3. There are 2*T*B constraints of the third type. For a given time t and buyer b one vector v has components v\hat{ }{s,b} _t=1 for each seller s, 0 otherwise, and has corresponding c=demand\hat{ }{b}_t, the demand generated by buyer b at time t. The other vector corresponding to this time/buyer pair has components v\hat{ }{s,b}_t=−1 for each seller s, and corresponding c=demand\hat{ } {b} _t.

Other constraints are optionally derived from requirements such as a maximum quantity to be bought from any one seller in a given time step, minima to be bought to a given seller in a given time step, etc. As an example of how this is done, consider the former case. The vector v for this constraint as v\hat{ } {s,b} _t=1 for all buyers b and specified time t and seller s; c is then the maximum quantity that can be bought from that seller.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. Apparatus for use in making a purchase decision regarding purchase of a plurality of units of a good or service at a particular purchasing time from a plurality of potential suppliers, the apparatus comprising means for determining or otherwise obtaining a total quantity of units of said good or service required to be purchased at said purchasing time as defined by one or more purchase orders relating to said purchasing time, means for accessing details of terms under which said good or service may be purchased from each of said potential suppliers at said purchasing time, and means for providing an indication of one or more consequences of allocating portions of said total quantity to be purchased among said plurality of potential suppliers.

2. Apparatus according to claim 1, wherein said terms are defined in contracts, with at least one contract being established in respect of each of said potential suppliers.

3. Apparatus according to claim 2, including a contract repository 200 in which details of each contract established in respect of said suppliers are stored.

4. Apparatus according to claim 3, wherein each contract is encoded prior to storage.

5. Apparatus according to claim 4, wherein each contract is encoded as a record prior to storage, each record including one or more of a unique contract identifier, a start date and an end date of the contract, a good type, and a delivery location.

6. Apparatus according to claim 5, wherein said terms are included in said encoded contract record.

7. Apparatus according to claim 6, wherein said terms include a volume discount expressed as a discount function, defining a discount as a function of a quantity of said good or service.

8. Apparatus according to claim 1, including means for storing details of said one or more purchase orders.

9. Apparatus according to claim 8, wherein the or each purchase order is encoded prior to storage thereof.

10. Apparatus according to claim 9, wherein each purchase order is encoded in terms of one or more of an order due date, a good type, a quantity of the good specified in the purchase order, and a buyer location.

11. Apparatus according to claim 1, including a linking table for recording links between contracts and purchase orders.

12. Apparatus according to claim 11, in which an aggregated quantity of goods or services purchased in respect of each contract is stored in said linking table.

13. Apparatus according to claim 1, including a procurement decision interface which provides a visual indication of said consequences.

14. Apparatus according to claim 13, wherein said procurement decision interface provides an indication of an average price per unit of a good required to be purchased, given that the total quantity of goods required at a specific purchasing time is allocated between a selected set of contracts in quantities prescribed by a user.

15. Apparatus according to claim 1, including a data structure for storing a repository of demand schedules.

16. (canceled)

17. A method for use in making a purchase decision regarding purchase of a plurality of units of a good or service at a particular purchasing time from a plurality of potential suppliers, the method comprising the steps of determining or obtaining a total quantity of units of said good or service required to be purchased at said purchasing time as defined by one or more purchase orders relating tosaid purchasing time, accessing details of terms under which said good or service may be purchased from each of said potential suppliers at said purchasing time and providing an indication of one or more consequences of allocating portions of said total quantity to be purchased among said plurality of potential suppliers.

18. (canceled)

19. Apparatus for use in making a purchase decision regarding purchase of a plurality of units of a good or service at a particular purchasing time from a plurality of potential suppliers, the apparatus comprising an input for receiving details of one or more purchase orders generated in respect of said purchasing time, and for receiving details of contracts relating to purchase of said good or service, at least one contract being defined in respect of each of said plurality of potential suppliers, said apparatus being arranged to define a link between said purchase orders and related contracts.

20. Apparatus for use in making a purchase decision regarding purchase of a plurality of units of a good or service at a current purchasing time from a plurality of potential suppliers, the apparatus comprising an input for receiving details of one or more purchase orders generated in respect of each of a plurality of previous purchasing times, and for receiving details of contracts relating to purchase of said good or service, at least one contract being defined in respect of each of said plurality of potential suppliers, and a processor for determining from said details of said one or more purchase orders a total quantity of said good or service purchased in respect of each of said contracts at said previous purchasing times and for updating said total quantities in respect of each of said contracts according to an allocation among said plurality of potential suppliers of a quantity of said good or service purchased at said current purchasing time.

21. Apparatus for use in making a purchase decision regarding purchase of a plurality of units of a good or service from a plurality of potential suppliers at each of a plurality of purchasing times within a predetermined period, the apparatus comprising means for receiving data representative of a total quantity of units of said good or service required to be purchased at each of said purchasing times, means for accessing details of terms under which said good or service may be purchased from each of said potential suppliers at said purchasing times, means for determining an optimal purchase decision regarding purchase of said plurality of units of said good or service based on a total quantity of units required to be purchased within said predetermined period and said terms, said optimal purchase decision being defined in terms of allocation among said plurality of potential suppliers of said total quantity of said good or service required to be purchased at each of said purchasing times so as to minimise a total cost of purchasing said good or service during said predetermined period.

22. Apparatus according to claim 21, wherein said terms include cumulative purchase discounts within said predetermined period.

23. Apparatus according to claim 21, wherein constraints are applied in respect of purchases from one or more of said suppliers.

24. Apparatus according to claim 21, wherein said terms are defined in respective contracts, at least one contract being defined for each of said potential suppliers.

25. Apparatus according to claim 24, arranged to perform a search of possible allocations of purchases to respective contracts.

26. Apparatus according to claim 25, wherein the possible allocations are corner cases.

27. A method for use in making a purchase decision regarding purchase of a plurality of units of a good or service from a plurality of potential suppliers at each of a plurality of purchasing times within a predetermined period, the method comprising the steps of receiving data representative of a total quantity of units of said good or service required to be purchased at each of said purchasing times, accessing details of terms under which said good or service may be purchased from each of said potential suppliers at said purchasing times, and determining an optimal purchase decision regarding purchase of said plurality of units of said good or service based on a total quantity of units required to be purchased within said predetermined period and said terms, said optimal purchase decision being defined in terms of allocation among said plurality of potential suppliers of said total quantity of said good or service required to be purchased at each of said purchasing times so as to minimise a total cost of purchasing said good or service during said predetermined period.
